(19) United States
(12) Patent Application Publication
(10) Pub. No.: US 2020/0278195 A1
(43) Pub. Date: Sep. 3, 2020

(54) MONITORING CABLES AND METHODS FOR MONITORING RAIL TRACKS

(71) Applicant: AFL Telecommunications LLC, Duncan, SC (US)

(72) Inventors: Craig Stratton, Spartanburg, SC (US); Stephen Linton, Cummings, GA (US); Dustin Dell, Duncan, SC (US); Dana DuToit, Chaska, MN (US)

(21) Appl. No.: 16/647,726

(22) PCT Filed: Sep. 19, 2018
(86) PCT No.: PCT/US2018/051621

§ 371 Date: Mar. 17, 2020

Related U.S. Application Data
(60) Provisional application No. 62/560,291, filed on Sep. 19, 2017.

(51) Int. Cl. G01B 11/16; B61L 23/04; G01L 1/24

(52) U.S. Cl. CPC G01B 11/16; G01L 1/242; B61L 23/042

(57) ABSTRACT

A monitoring cable includes an outer jacket having a generally rectangular cross-sectional profile. The monitoring cable further includes a strain monitoring unit disposed within the outer jacket, the strain monitoring unit including a plurality of optical fibers embedded in a potting layer. The monitoring cable further comprises a protective unit disposed within the outer jacket and spaced from the strain monitoring unit, the protective unit including an optical fiber disposed within a metal outer jacket. A method for monitoring a rail track includes attaching a monitoring cable to the rail track. The method further includes monitoring strain of the rail track by measuring movement of the optical fibers of the strain monitoring unit.

### CROSS-REFERENCE TO RELATED APPLICATIONS

The present application claims priority to U.S. Provisional Patent Application Ser. No. 62/560,291, filed on Sep. 19, 2017, the disclosure of which is incorporated by reference herein in its entirety.

### FIELD

The present disclosure relates generally to monitoring cables, such as for use with rail tracks and rail cars, and more particularly to improved monitoring cables which facilitate strain, temperature, and/or acoustics monitoring.

### BACKGROUND

The rail industry has challenges in effective means of monitoring track/train integrity. Rail track/train defects that have gone undetected have led to the derailment of cargo and passenger trains. For example, one significant issue is “rail kink” due to temperature fluctuations. Existing methods of rail/train monitoring such as periodic visual inspection and point sensors do not fill the need of distributed, continuous monitoring of rail tracks.

Continuous monitoring of rail trains with distributed sensing optical fibers and cables have been developed via off-track cable placement. However, the off-track placement of sensor cables results in the cables having a limited ability to detect evolving track/train degradation.

Accordingly, improved rail track and rail car monitoring apparatus would be desired.

### BRIEF DESCRIPTION

Aspects and advantages of the invention will be set forth in part in the following description, or may be obvious from the description, or may be learned through practice of the invention.

In accordance with one embodiment, a monitoring cable is provided. The monitoring cable includes an outer jacket having a generally rectangular cross-sectional profile. The monitoring cable further includes a strain monitoring unit disposed within the outer jacket, the strain monitoring unit including a plurality of optical fibers embedded in a potting layer. The monitoring cable further comprises a protective unit disposed within the outer jacket and spaced from the strain monitoring unit, the protective unit including an optical fiber disposed within a metal outer jacket.

In accordance with another embodiment, a method for monitoring a rail track is provided. The method includes attaching a monitoring cable to the rail track. The method further includes monitoring strain of the rail track by measuring movement of the optical fibers of the strain monitoring unit.

In some embodiments, the method further includes monitoring a temperature of the rail track by measuring backscattered light along the optical fiber of the protective unit.

In some embodiments, the method further includes monitoring acoustics at the rail track by measuring vibrations along the optical fiber of the protective unit or the optical fibers of the strain monitoring unit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE FIGURES

A full and enabling disclosure of the present invention, including the best mode thereof, directed to one of ordinary skill in the art, is set forth in the specification, which makes reference to the appended figures, in which:

FIG. 1 is a cross-sectional view of a monitoring cable attached to a rail track in accordance with embodiments of the present disclosure;

FIG. 2 is a perspective cross-sectional view of a monitoring cable in accordance with embodiments of the present disclosure; and

FIG. 3 is a flow chart illustrating methods in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction.

In exemplary embodiments, the present disclosure is generally directed to a rectangular cable intended for permanent attachment to the vertical web of a railroad track. The cable includes multiple elements including fiber optic bearing stainless steel tubes with loosely coupled optical fibers contained within for the purpose of temperature compensation allowing for accurate measurement and deduction of strain from a specially constructed tightly bound optical unit. The design incorporates dimensions for the stainless steel tubes to be larger than the specially fabricated tightly bound unit such that the steel tubes provide a level of protection for this tightly bound unit. Additionally, the placement of the stainless steel tubes enhances the mechanical protection offered as well as the measurement accuracy.

The stainless steel tubes can be filled with a plurality of optical fibers which can be used for additional purposes such as communications and signaling along the railway. In addition to be specially designed for the purpose of measuring strain on the railroad track, the cable can transduce acoustic signals as well. This multi-function sensing cable is ideal for railway surveillance wherein track conditions require continual monitoring to ensure safety; rail car monitoring for conditions such as out-of-round wheels which may lead to significant vibration and deterioration of the track. Additional functional capabilities may include speed and direction monitoring of railway vehicles, identification of hazards such as rock falls or other large objects that enter the railway; and security of the wayside assets via intrusion detection capability.

Furthermore, the cable is constructed utilizing flame retardant compounds with limited smoke release and zero halogen under fire conditions. The cable design is intended to achieve an OFCG-LS/FT4 listing in order to comply with the requirements of NFPA 130 which will allow the safe and proper use of the cable in tunnels and confined spaces along the railway.

This rectangular cable structure has a number of useful attributes for rail monitoring including distributed temperature, distributed strain, and distributed acoustic sensing possibilities. In addition, this structure provides unique protection of the strain sensing region of the cable via fiber-in-metal tube substructure of the cable.

Fiber-in-metal tube sub-structures are used in this cable structure for tensile strength, protection, and strain free optical fibers. Fiber strand units are used in this cable structure to provide strain coupled fiber structures within said cable structure to allow for distributed strain monitoring. Unique jacketing materials allow for low smoke, zero halogen ratings and outdoor exposure of the said cable structure. A rectangular structure offers consistent, high speed installation of the sensor cable to the track rails.

By combining these sub-structures into this unique cable design, a linear sensor is provided that is capable of addressing a simplified installation technique, distributed strain sensing with temperature compensation, distributed temperature measurements, distributed acoustic measurements, the needed tensile strength and protection of sensing fibers, and a flame/toxicity rating required for this application.

Referring now to FIG. 1, one embodiment of a rail track 10 is illustrated. As shown, the track 10 includes one or more beams 12. Each beam 12 may be mounted to a railpad 14 which may be supported directly or indirectly by the ground 16. In some embodiments, one or more ties or sleepers 18 may be provided. The ties 18 may extend between the beams 12, and between the railpad 14 and the ground 16.

Beams 12 are generally formed from a metal, such as steel. Each beam 12 may include a vertical web 20. Further, each beam may include one or more horizontal webs 22. For example, in some embodiments, the beams 12 may be I-beams.

It should be understood that the present disclosure is not limited to the above-described rail track 10 embodiment, and rather that any suitable rail track is within the scope and spirit of the present disclosure.

As further illustrated in FIG. 1, a monitoring cable 100 may be attached to one or more of the beams 12 of a rail track 10. In exemplary embodiments, the cable 100 may be attached to the vertical web 20 of a beam 12. Such attachment in exemplary embodiments may be a permanent attachment, such as via a suitable adhesive. The monitoring cable 100 may extend generally longitudinally along the vertical web 20. As discussed herein, the monitoring cable 100 may advantageously provide improved and continuous monitoring of strain, temperature, and/or acoustics associated with beam 12 to which the cable 100 is attached and the track 10 generally.

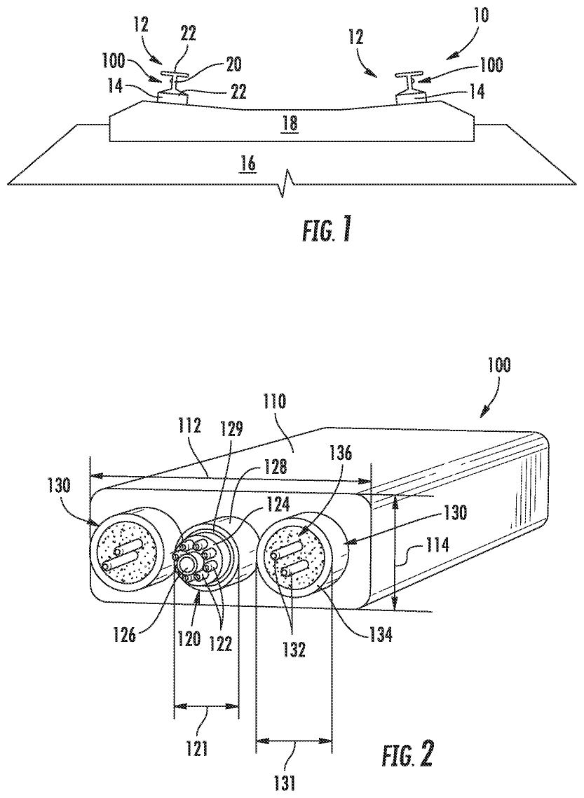

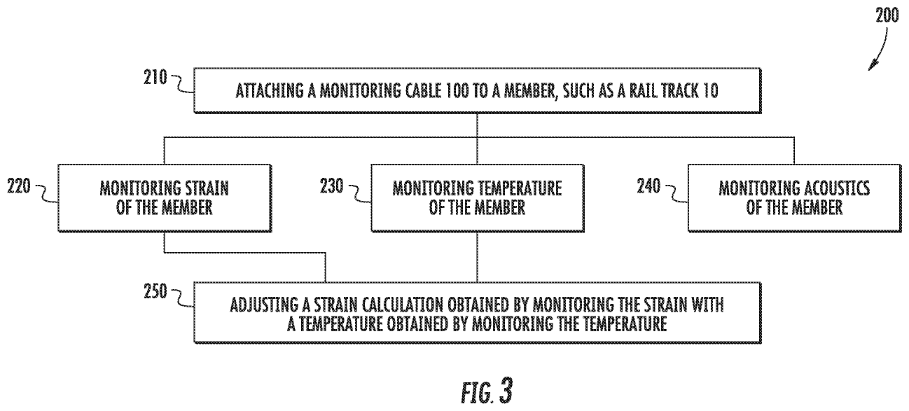

Referring now to FIG. 2, one embodiment of a cable 100 in accordance with the present disclosure is provided. Monitoring cable 100 can advantageously utilize various optical fibers in certain units within the cable to monitor strain, temperature and/or acoustics associated with a member to which the cable 100 is attached, such as a beam 12 and track 10 generally as discussed above.

Cable 100 may include an outer jacket 110 which may serve as the outermost exterior layer of the cable 100. In exemplary embodiments, outer jacket 110 may have a generally rectangular cross-sectional profile. For example, the cross-sectional profile may have a rounded rectangular shape, as shown.

Jacket 110 and cable 100 generally may have a maximum width 112 and a maximum height 114. In exemplary embodiments, the maximum width 112 is greater than the maximum height 114. For example, the maximum width 112 may be between 6 millimeters and 14 millimeters, such as between 8 millimeters and 12 millimeters, such as between 9 millimeters and 11 millimeters, such as about 10 millimeters. The maximum height 114 may be between 3 millimeters and 7 millimeters, such as between 4 millimeters and 6 millimeters, such as about 5 millimeters.

Jacket 110 is in exemplary embodiments formed from a polymer material. For example, jacket 110 may be formed from a thermoplastic or a thermoset. In some embodiments, jacket 110 is formed from a polyolefin, such as cross-linked polyolefin, or from a thermoplastic compound. In exemplary embodiments, the jacket 110 is formed from a low smoke/zero halogen material. For example, in some embodiments, the jacket 110 and the cable 100 generally may achieve an OFCG-LS/FT4 listing as stated in the UL 1685 standard as issued in 2015. Additionally or alternatively, the jacket 110 and the cable 100 generally may meet the requirements of NFPA 130 as issued in 2017.

Cable 100 may further include a strain monitoring unit 120 which is disposed within the outer jacket 110. In exemplary embodiments as shown, the unit 120 is embedded in the outer jacket 110. The strain monitoring unit 120 may be a sub-unit of the cable 100 which includes optical fibers disposed within one or more outer layers.

For example, unit 120 may include a plurality of optical fibers 122 which are embedded in a potting layer 124. The potting layer 124 may, for example, be a suitable potting resin such as a ultraviolet resin. In some embodiments, a central strength member 126 may be provided. Central strength member 126 may be a fiber reinforced polymer strength members, such as a fiberglass strength member. In these embodiments, the optical fibers 122 may surround the central strength member 126, such as in an annular array. The central strength member 126 may also be embedded in the potting layer 124.

An outer jacket 128 may serve as an outermost exterior layer of the unit 120 in which the optical fiber 122, potting layer 124, and strength member 126 may be disposed. Outer jacket 128 may, for example, be formed from a suitable thermoplastic, such as a thermoplastic elastomer. In some embodiments, an inner jacket 129 may be disposed within the outer jacket 128. The optical fiber 122, potting layer 124, and strength member 126 may be disposed within the inner jacket 129. Inner jacket 129 may be formed from, for example, a suitable epoxy. When inner jacket 129 is utilized, inner jacket 129 may contact outer jacket 128, and potting layer 124 may contact inner jacket 129. When no inner jacket 129 is utilized, potting layer 124 may contact outer jacket 128.

Strain monitoring unit 120 may have a generally circular or oval cross-sectional profile, and may have a maximum outer diameter 121. For example, the maximum outer diameter 121 may be between 1.7 and 2.3 millimeters, such as between 1.8 and 2.2 millimeters, such as between 1.9 and 2.1 millimeters, such as approximately 2.0 millimeters.

Because the optical fibers 122 are embedded in the potting layer 124, the strain monitoring unit 120 is particularly advantageous for use in monitoring strain. When the cable 100 is attached to a member, such as to a beam 12 or rail track 10 generally, movement of the member may cause strain and/or compression of the optical fibers 122 due to associated movement of the optical fibers 122. Strain of the member (such as the beam 12 or rail track 10 generally) can be correlated to such movement, such that strain of the member is monitored based on movement of one or more optical fibers 122.

In some embodiments, one or more optical fibers 122 can additionally or alternatively be utilized to monitor acoustics at the member (such as the beam 12 or rail track 10 generally). When the cable 100 is attached to a member, changes in acoustics due to, for example, sudden loud noises, may cause vibrations along the optical fibers 122. Such change in acoustics at the member can be correlated to such vibrations, such that acoustics at the member is monitored based on vibrations along one or more optical fibers 122.

Cable 130 may further include one or more protective units 130. The protective units 130 may be disposed within the outer jacket 110, and each protective unit 130 may be spaced from the strain monitoring unit 120. In some embodiments, a plurality of protective units 130, such as in exemplary embodiments two protective units 130, may be provided. In exemplary embodiments as shown, each unit 130 is embedded in the outer jacket 110. The protective units 130 may each be a sub-unit of the cable 100 which includes optical fibers disposed within one or more outer layers.

For example, each protective unit 130 may include one or more optical fibers 132, such as in exemplary embodiments a plurality of optical fibers 132, disposed within a metal outer jacket 134. The metal outer jacket 134 may be the outermost exterior layer of the protective unit 130. In exemplary embodiments, the metal outer jacket 134 is formed from a steel, such as a stainless steel. Additionally, in some embodiments, a gel 136 may be disposed within the metal outer jacket 134. Gel 136 may generally surround and be in contact with the optical fibers 132, and may be in contact with the outer jacket 134. In exemplary embodiments, gel 136 may be a thixotropic gel.

Each protective unit 130 may have a generally circular or oval cross-sectional profile, and may have a maximum outer diameter 131. For example, the maximum outer diameter 131 may be between 2.1 and 2.7 millimeters, such as between 2.2 and 2.6 millimeters, such as between 2.3 and 2.5 millimeters, such as approximately 2.4 millimeters. In exemplary embodiments, the maximum outer diameter 131 of each protective unit 130 may be greater than the maximum outer diameter 121 of the strain monitoring unit 120. Such greater maximum outer diameter 131 allows the protective unit(s) 130 to provide a level of protection from damage to the strain monitoring unit 120.

Optical fibers 132 can be utilized to monitor the temperature of the member (such as the beam 12 or rail track 10 generally) to which the cable 100 is attached. When the cable 100 is attached to a member, changes in temperature may cause changes in backscattered light along the optical fibers 132. Such change in temperature of the member can be correlated to such backscattered light, such that temperature at the member is monitored based on measurement of the backscattered light along one or more optical fibers 132. Notably, the temperature measurements can be utilized in monitoring of the strain as discussed above, by serving to compensate for temperature variabilities in the unit 120, such that the strain measurements of the unit 120 are advantageously more accurate.

In some embodiments, one or more optical fibers 132 can additionally or alternatively be utilized to monitor acoustics at the member (such as the beam 12 or rail track 10 generally). When the cable 100 is attached to a member, changes in acoustics due to, for example, sudden loud noises, may cause vibrations along the optical fibers 132. Such change in acoustics at the member can be correlated to such vibrations, such that acoustics at the member is monitored based on vibrations along one or more optical fibers 132.

In exemplary embodiments, the plurality of protective units 130 and the strain monitoring unit 120 are aligned in a linear array, such as along the width 112. As shown, in exemplary embodiments, the strain monitoring unit 120 is disposed between neighboring protective units 130.

Referring now to FIG. 3, the present disclosure is further directed to methods 200 for monitoring members such as rail tracks 10. A method 200 may include, for example, the step 210 of attaching a monitoring cable 100 to the member, such as to the rail track 10, as discussed herein. A method 200 may further include, for example, the step 220 of monitoring strain of the member, such as the rail track 10, as discussed herein. A method 200 may further include, for example, the step 230 of monitoring temperature of the member, such as the rail track 10, as discussed herein. A method 200 may further include, for example, the step 240 of monitoring acoustics at the member, such as the rail track 10, as discussed herein. A method 200 may further include, for example, the step 250 of adjusting a strain calculation obtained by monitoring the strain with a temperature obtained by monitoring the temperature. As discussed herein, the adjusted strain calculation may advantageously be relatively more accurate, thus providing improved strain monitoring of members such as rail tracks 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A monitoring cable, comprising:
an outer jacket having a generally rectangular cross-sectional profile;
a strain monitoring unit disposed within the outer jacket, the strain monitoring unit comprising a plurality of optical fibers embedded in a potting layer;
a protective unit disposed within the outer jacket and spaced from the strain monitoring unit, the protective unit comprising an optical fiber disposed within a metal outer jacket.

2. The monitoring cable of claim 1, wherein a maximum diameter of the protective unit is greater than a maximum diameter of the strain monitoring unit.

3. The monitoring cable of claim 1, wherein the protective unit is a plurality of protective units.

4. The monitoring cable of claim 3, wherein the plurality of protective units and the strain monitoring unit are aligned in a linear array within the outer jacket.

5. The monitoring cable of claim 1, wherein the strain monitoring unit and protective unit are embedded in the outer jacket.

6. The monitoring cable of claim 1, wherein the outer jacket has a rounded rectangular cross-sectional profile.

7. The monitoring cable of claim 1, wherein the outer jacket is formed from a low smoke/zero halogen material.

8. The monitoring cable of claim 1, wherein the optical fiber of the protective unit is a plurality of optical fibers.

9. The monitoring cable of claim 1, wherein the protective unit further comprises a gel disposed within the metal outer jacket.

10. The monitoring cable of claim 1, wherein the metal outer jacket is a stainless steel outer jacket.

11. A method for monitoring a rail track, the method comprising:
attaching a monitoring cable to the rail track, the monitoring cable comprising:
an outer jacket having a generally rectangular cross-sectional profile;
a strain monitoring unit disposed within the outer jacket, the strain monitoring unit comprising a plurality of optical fibers embedded in a potting layer;
a protective unit disposed within the outer jacket and spaced from the strain monitoring unit, the protective unit comprising an optical fiber disposed within a metal outer jacket; and
monitoring strain of the rail track by measuring movement of the optical fibers of the strain monitoring unit.

12. The method of claim 11, further comprising monitoring a temperature of the rail track by measuring backscattered light along the optical fiber of the protective unit.

13. The method of claim 11, further comprising monitoring acoustics at the rail track by measuring vibrations along the optical fiber of the protective unit or the optical fibers of the strain monitoring unit.

14. The method of claim 13, wherein the acoustics are monitored by measuring vibrations along the optical fibers of the strain monitoring unit.

15. The method of claim 11, wherein a maximum diameter of the protective unit is greater than a maximum diameter of the strain monitoring unit.

16. The method of claim 11, wherein the protective unit is a plurality of protective units.

17. The method of claim 16, wherein the plurality of protective units and the strain monitoring unit are aligned in a linear array within the outer jacket.

18. The method of claim 11, wherein the strain monitoring unit and protective unit are embedded in the outer jacket.

19. The method of claim 11, wherein the outer jacket is formed from a low smoke/zero halogen material.

20. The method of claim 11, wherein the protective unit further comprises a gel disposed within the metal outer jacket.
